(19) United States
(12) Patent Application Publication
(10) Pub. No.: US 2025/0131098 A1
(43) Pub. Date: Apr. 24, 2025

(54) IDENTITY AND ACCESS MANAGEMENT INFORMED ATTACK PATH DISCOVERY

(71) Applicant: Palo Alto Networks, Inc., Santa Clara, CA (US)

(72) Inventors: Ajaya Neupane, San Jose, CA (US); Ruben Dario Torres Guerra, Menlo Park, CA (US); Alok Tongaonkar, San Jose, CA (US)

(21) Appl. No.: 18/492,018

(22) Filed: Oct. 23, 2023

(51) Int. Cl. G06F 21/57

(52) U.S. Cl. CPC G06F 21/577; G06F 2221/034

(57) ABSTRACT

A resource attack path detector parses IAM policies to identify entities and permissions relating the entities. The resource attack path detector builds a directed graph that represents the entities, which includes principals and resources, with nodes and relates nodes based on permissions. The resource attack path detector indicates properties of the nodes and edges in the graph based on information about the entities. The attack path detector assigns weights to the nodes and edges based on the properties of the nodes and edges. After the graph is complete, the attack path detector can analyze the graph to reveal attack paths. The resource attack path detector scores attack paths and then ranks and/or filters the attack paths based on the scoring. In addition, the attack path detector can extract patterns from attack paths and create security rules with the extracted patterns.

### BACKGROUND

The disclosure generally relates to cybersecurity (e.g., CPC H04L 63/1440 and G06F 21/00).

A privilege in the context of cybersecurity is a right or permission or set of rights/permissions granted to an entity, such as a process, user, account, identity, etc. Access to resources in a cloud environment is managed with systems, such as Identity and Access Management (IAM) systems and/or Privileged Access Management (PAM) systems. Privilege escalation involves an attacker exploiting a vulnerability or a misconfiguration that allows escalation of a privilege. Privilege escalation can be horizontal or vertical and an attacker can perform multiple escalations.

### BRIEF DESCRIPTION OF THE DRAWINGS

Embodiments of the disclosure may be better understood by referencing the accompanying drawings.

FIG. 1 is a diagram of an example cloud resource attack path detector.

FIG. 2 is an example graph or sub-graph that could be built by a cloud resource attack path detector.

FIG. 3 is a flowchart of example operations for building a resource access graph based on parsing identity and access management (IAM) policies.

FIG. 4 is a flowchart of example operations for augmenting a resource access graph with a simulated access path.

FIG. 5 is a flowchart of example operations for identifying attack paths to valuable resources of an organization.

FIG. 6 is a flowchart of example operations to identify high risk digital identities with the resource access graph.

FIG. 7 is a flowchart of example operations for creating a security rule from an access path based on a detected attack.

FIG. 8 is a flowchart of example operations for creating a security rule from an access path based on a property matching.

FIG. 9 depicts an example computer system with an IAM policy informed resource attack path detector.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### INTRODUCTION

Identity and access management (IAM) refers to the management of access to resources by defining which principals have what kind of access to which resources in terms of permissions and roles. A principal, also referred to as an identity, is an entity that can be authenticated and granted a role. Examples of a principal include a service account, compute instance, user, and group. Although a role could be defined with a single permission, a role is typically a group of permissions identifiable with a role identifier. A role binding is the binding or associating of one or more principals to a role and can also specify conditions for access. A collection of role bindings forms an IAM policy which is then attached to a resource (e.g., a storage object or workload).

Managing permissions, roles, and groups in a cloud environment is a complex, ongoing task that increases in complexity with creation of entities (i.e., principals and resources), roles, role bindings, policies, etc. Managing many entities and various permissions among them can be challenging before considering cybersecurity implications. Within the dense web of entities and permissions relating the entities, attack paths go unseen and allow attackers opportunities to access an organization's “crown jewels.” Crown jewels in an information technology context are assets considered as having high intrinsic value (e.g., source code) and/or high reputational value due to the potential reputational harm if leaked (e.g., leakage of customer data). An attack path to a cloud hosted crown jewel is typically by means of assuming or passing roles with elevated permissions.

### Overview

A resource attack path detector as disclosed herein facilitates discovery of possible attack paths to access an organization's crown jewels. The resource attack path detector parses IAM policies to identify entities and permissions relating the entities. The resource attack path detector builds a directed graph that represents the entities, which includes principals and resources, with nodes and relates nodes based on permissions. The resource attack path detector indicates properties of the nodes and edges in the graph based on information about the entities (e.g., indicating that the entity is a role or compute instance). The attack path detector assigns weights to the nodes and edges based on the properties of the nodes and edges. After the graph is complete, the attack path detector can analyze the graph to reveal attack paths. The resource attack path detector scores attack paths and then ranks and/or filters the attack paths based on the scoring. In addition, the attack path detector can extract patterns from attack paths and create security rules with the extracted patterns.

### Example Illustrations

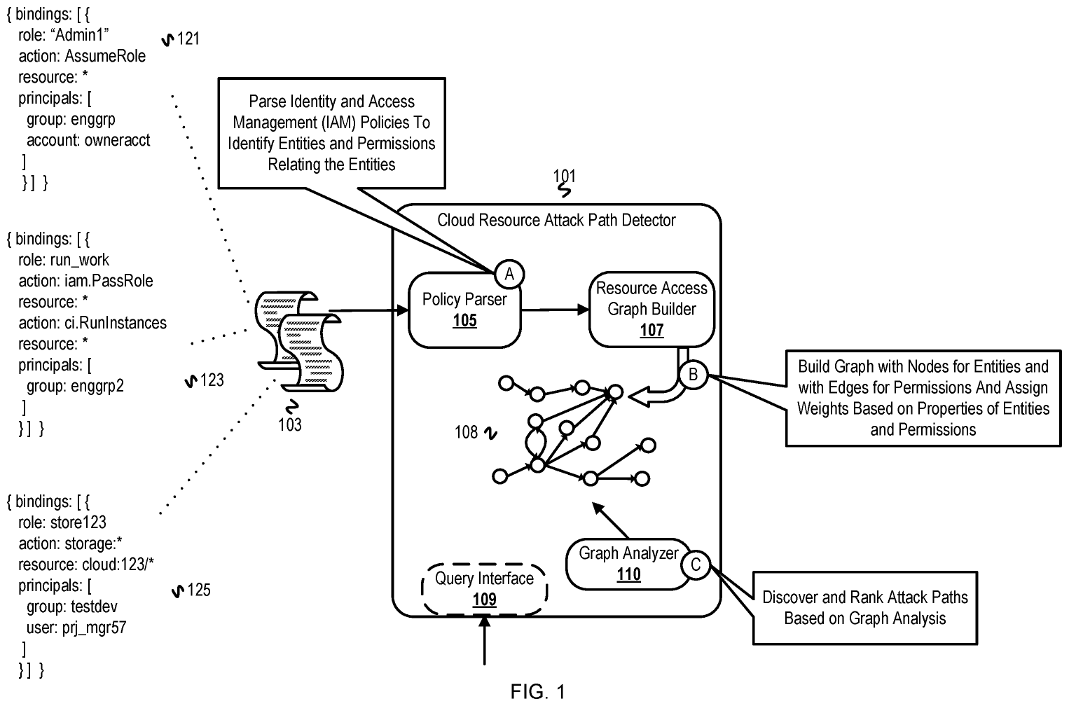

FIG. 1 is a diagram of an example cloud resource attack path detector. A cloud resource attack path detector 101 parses IAM policies 103 and builds a resource access graph 108 that represents entities, including resources associated with crown jewels, and analyzes the graph to detect resource access paths that are potential attack paths. The cloud resource attack path detector 101 is depicted with a policy parser 105, a resource access graph builder 107, a graph analyzer 110, and a query interface 109. The query interface 109 is depicted in a dashed line to indicate the optional presence of corresponding functionality.

FIG. 1 is annotated with a series of letters A-C, each of which represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the policy parser 105 parses the IAM policies 103 to identity entities and permissions relating the entities. Different IAM implementations have different policy implementations. For instance, a system may define a policy as a role having permissions to a resource and attach principals to the user. As another example, an IAM system may create a policy with roles and principals bound to the role and then attach the policy to a resource. Implementations can vary how entities are related with permissions yielding access paths from principals to resources, but the different implementations still relate entities with permissions resulting in access paths. Likewise, different implementations can use different technologies for encoding IAM policies. The policy parser 105 will parse the policies 103 according to the format and syntax used by the IAM system or platform for IAM policies. The example policy entries of FIG. 1 are not specific to an IAM system.

The cloud resource attack path detector 101 parses the policies 103 to identify the principals, resources, and permissions. FIG. 1 includes example policy entries 121, 123, 125 that refer to role bindings to illustrate the example. The policy entry 121 includes role bindings that bind a role “Admin1” to principals “enggrp” (a user group) and a service account “owneracct.” The permission of the role is signified by the action “AssumeRole,” meaning that the principals bound to the role can obtain short term credentials to access any resource as indicated by the wildcard “*” for the resource field. The policy entry 123 includes a role binding that binds a role “run_work” to a group “enggrp2.” The role run_work provides permission to perform two actions on any resource as signified by the wildcard. The two permitted actions include the action “iam. PassRole” and the action “ci.RunInstances.” The action iam. PassRole allows the bound principals to pass the run_work role to any resource (e.g., a workload). The ci.RunInstances action instantiates an entity that can be instantiated, such as a compute instance. This policy entry 123 allows a bound principal to instantiate an entity and pass the run_work role to that instantiated entity. The policy entry 125 binds a role “store123” to a group “testdev” and to a user “prj_mgr57.” The role store123 includes a permission to run any command (e.g., an application programming interface (API) defined function of a cloud platform) that begins with “storage”. The policy entry 125 is attached to any resource with an identifier in a namespace “cloud:123”.

At stage B, the resource access graph builder 107 builds a graph 108 based on the entity and permissions identified by the policy parser 105. The resource access graph builder 107 (hereinafter “graph builder”) creates nodes to represent the entities and connects the nodes with edges that represent permissions. Embodiments can parse the policies 103 and generate an output(s) of tuples with the principals ordered according to the relationship based on the permissions which the graph builder 107 can process to build the graph 108. Embodiments can output parsed information at varying granularity (e.g., each role binding or for each resource) to the graph builder 107 depending upon the implementation of IAM policies for incremental building of the graph 108 according to output fed from the policy parser 105 to the graph builder 107. Embodiments can implement the graph builder 107 to invoke the policy parser 105 as it processes security policies. Referring to the policy entry 125 as an example illustration, the policy parser 105 identifies from the entry 125 the relationship that testdev has a role store123 that permits access to any storage object in the namespace cloud:123 with any action starting with storage. From this relationship, the graph builder 107 creates nodes for the principal, the role, and the resource. The graph builder 107 connects the node representing testdev to the role store123 with an edge indicating binding or attachment and directionality based on the supporting data (e.g., direction from principal to role assumed or based on assignment). The graph builder 107 then connects, with an edge representing permissions for the storage action, the store123 role node to a resource node that represents any storage object in the namespace cloud:123.

At stage C, the graph analyzer 110 analyzes the graph 108 to discover and rank attack paths. The graph analyzer 110 discovers attack paths in the graph 108 and ranks the discovered attack paths. To discover attack paths, the graph analyzer 110 can traverse the graph 108 from source nodes corresponding to identities and/or sink nodes corresponding to resources that can host assets. The graph analyzer 110 can analyze the graph 110 according to configured parameters. For example, a configuration file can be maintained that identifies resources that host sensitive and/or high-value assets. The graph analyzer 110 ranks the discovered attack paths based on the weights assigned to the nodes and edges of the discovered attack paths. The graph analyzer 110 can then provide the discovered information as an alert or notification, for example. As the graph 108 may be updated periodically and/or based on detected events (e.g., addition of a resource), the analysis can be triggered after each update.

Implementation can include a query interface to specify parameters for attack path discovery and/or exploration of a visualization of a resource access graph. The query interface 109 can receive a query and provide a response to the query based on analysis by the graph analyzer 110. The query interface 109 may be a user interface and/or an API. Queries can vary with parameters according to the intent of the query. Examples of query parameters include entity identifiers and entity properties. A query parameter can indicate a type of query, such as attack path discovery, node centrality, and rule extraction. Thus, queries can be presented to discover attack paths to a specified resource, to discover attack paths from a specified principal, nodes common across attack paths (“choke points”), etc. In the case of a query, the graph analyzer 110 analyzes the graph 108 according to the query and assembles the information extracted from the graph 108 (e.g., ranked attack paths) into a form consumable by the query interface 109. For example, the graph analyzer 110 can structure the information and encode the structured information into a format expected by the query interface 109, such as a defined JavaScript® Object Notation (JSON) object. As another example, the graph analyzer 110 returns the extracted information in an in-memory data structure that the query interface 109 uses to generate a response for presentation (e.g., a notification, a visualization, etc.)

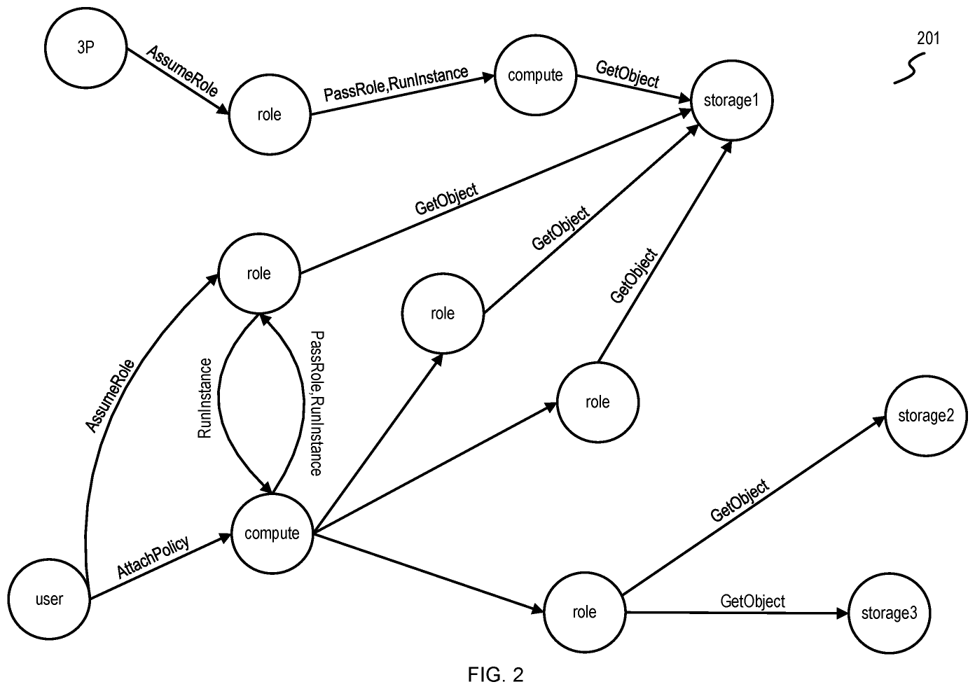

FIG. 2 is an example graph or sub-graph that could be built by the cloud resource attack path detector 101. A graph 201 includes three nodes representing storage objects, two nodes representing compute instance resources, five nodes representing roles, a node representing a user, and a node representing a third party labeled as “3P.” The 3P node can represent an external account or user. A query for attack paths to the storage node representing “storage 1” reveals attack paths to storage1 corresponding to four incoming edges. Note that an attack path may be one that has been used or a potential attack path. An attack path from the 3P node to storage1 traverses a compute instance node and a role node. The principal 3P has an AssumeRole permission to a role that allows for actions PassRole and RunInstance. With these actions, the 3P principal can instantiate a compute instance and pass the role to the instantiated compute instance. The passed role also includes a GetObject action that can be performed by the instantiated compute instance to access storage1. From the principal “user”, there are multiple attack paths to storage1 via three incoming edges to the storage1 node. The user node connects to a role node and a compute instance node with edges AssumeRole and AttachPolicy, respectively. Two of the attack paths from user traverse the compute instance node and branch to different role nodes that connect to storage1 with GetObject edges. Since the role is a common node on different attack paths it could be indicated as a choke point node if relevant to a query. Another set of attack paths includes the AssumeRole edge from user to role that can then branch to different paths to storage1: a GetObject edge from role to storage1 and a RunInstance edge from the role to the compute instance node already connected to the user node by the AttachPolicy edge. Each of the two attack paths branching from the compute instance node then traverses a role node before reaching the storage1 node. Each of the role nodes reach the storage1 node with an edge annotated with the GetObject action granted by the permission of role node. An attack path that starts from the user and traverses the role prior to arriving at the compute instance node includes an edge from the role to the compute instance node labeled RunInstance which indicates that the role node can grant permission to perform the action RunInstance for another compute resource (i.e., instantiate another compute instance). Many other scenarios can be represented in a resource access graph than what is depicted in FIG. 2. For instance, an IAM system may have trust relationships that convey implied trust to child resources (e.g., a compute instance created by another compute instance). The cloud resource attack path detector 101 can be programmed to build a graph that represents child resources with nodes and connects these nodes with other entities with permissions inherited from a parent node based on this implied trust.

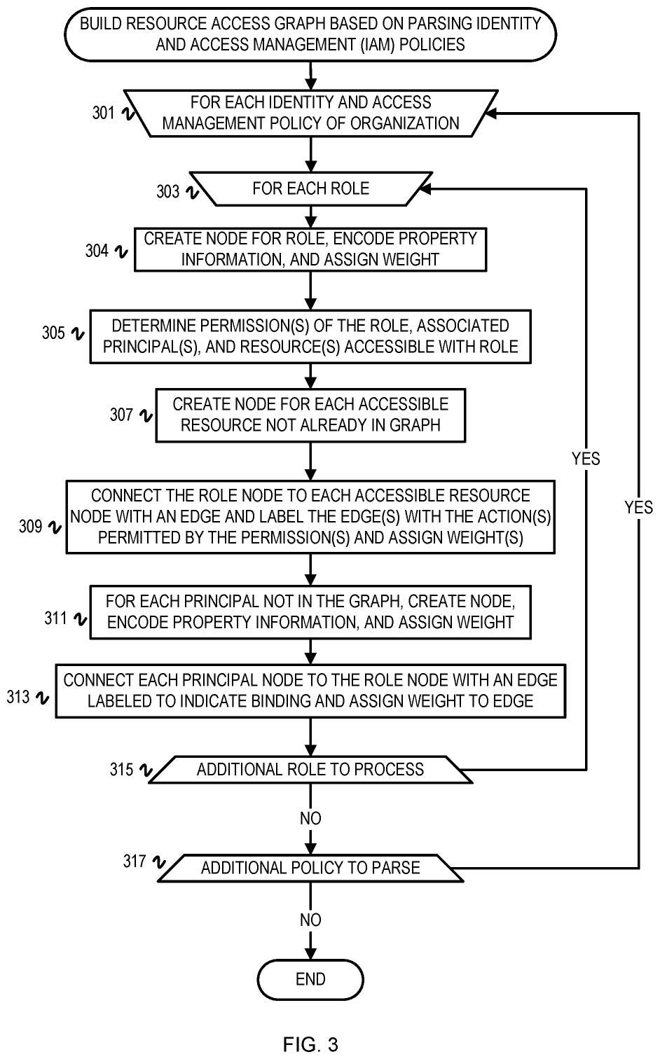

FIG. 3 is a flowchart of example operations for building a resource access graph based on parsing IAM policies. The example operations are described with reference to an attack path detector (truncation of cloud resource attack path detector) for consistency with the earlier figures and ease of understanding. The name chosen is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

At block 301, the attack path detector begins processing each IAM policy of an organization. The attack path detector may retrieve the policies by obtaining documents or files, such as JavaScript® Object Notation (JSON) documents, from an IAM system. The attack path detector may have functionality to parse multiple languages and/or formats. In this case, the attack path detector determines the language or format used by the IAM system and invokes or loads the corresponding parser. In addition, the attack path detector can configure a parser for a grammar used by an IAM system for the parser. Embodiments may parse all the policies prior to graph building and feed in a list or data structure of tuples with each tuple indicating a relationship of entity, permission/action, and entity. Also, information encoded into elements of the graph may be associated external to the role associations or at a higher level, such as a policy or account level, with the policy. As an example, indication of administrator permission may be at policy level, indicated for a role, and/or indicated for a user identity (e.g., a group). As another example, one or more policies may be associated with an account being monitored. This information can be encoded into the graph elements (e.g., propagated to all nodes or resource nodes) or separately indicated and considered in scoring at a graph level instead of path level (e.g., accounted for in scoring any path).

At block 303, the attack path detector begins processing each role defined in the IAM policy. Regardless of whether a policy is attached to a principal or a policy is attached to a resource or other IAM policy implementation variation, a role has permissions that are granted to a principal associated or bound to the role. And the permissions indicate the action(s) permitted to access a resource(s). This may involve reading one document, multiple documents, querying the IAM system, etc. Indeed, some of the information encoded into graph elements may be retrieved from the IAM system or another system using the identifier of the entity.

At block 304, the attack path detector creates a node that represents the role. The attack path detector encodes or decorates the node with information about the role, such as role identifier/name. The attack path detector also assigns a weight to the role nodes. The attack path detector can determine weights from a configuration file. For example, any role node may be assigned a same weight that can account for multiple roles in a path. Implementations likely assign substantially greater weights to crown jewels and weights that discriminate among permissions or actions common in lateral movement based attacks.

At block 305, the attack path detector determines the relationship(s) created by the role. The attack path detector determines a permission(s) granted by the role, associated principal(s), and resource(s) accessible with the role. The role definition indicates one or more permissions, which can also be referred to as permitted actions. Of particular interest in IAM systems are permissions that relate to granting or passing short term credentials and elevated permissions. If the attack path detector employs inline parsing of policies, the attack path detector determines the permission, principal, and resource based on field identifiers.

At block 307, the attack path detector creates a node for each accessible resource not already in the graph. Since another role may have permissions that allow access of a resource, the resource may already be present in the graph. This can be determined with the information encoded into the nodes. In addition to a resource identifier, the attack path detector encodes other information, such as resource type and account identifier.

At block 309, the attack path detector connects the role node to each accessible resource node with an edge representing each action permitted by the permission(s) that allows access to the resource node. A role can indicate multiple actions permitted to access a resource or multiple resources. The attack path detector adds an edge for each connection and labels the edge to indicate the permission(s) and/or action that is the basis for the connection. A permission has one or more corresponding actions allowed by the permission. But the corresponding action is not necessarily an action that can be executed or invoked (e.g., API function). For instance, a role may define a type of principal that can assume the role. While “assuming” the role can be considered the corresponding action, there likely is no corresponding action to be invoked or executed. The attack path detector also assigns a weight to the edge. The weight assigned to an edge can vary based on the action(s) corresponding to the permission(s) represented by the edge.

At block 311, the attack path detector updates the graph for each principal bound to the role but not already in the graph. The attack path detector creates a node for the principal, encodes property information, and assigns a weight. Examples of the property information encoded into a principal node include identifier, principal type (e.g., user, group, compute instance), and security information (e.g., age of credentials, re-use of credentials, principal reputation, whether the principal is a third-party principal, etc.). Weights may vary based on the encoded information.

At block 313, the attack path detector connects each principal node to the role node with an edge labeled to indicate the binding. The label for the edge connecting a principal to a role can vary depending upon the IAM policy implementation. The label indicates that the principal has been bound to the role, whether by command line configuration or policy attachment. Embodiments indicate whether the assumption or binding of a role to a principal is short lived or not. The attack path detector can use the distinction of a long or short lived binding to determine weight assignment.

At block 315, the attack path detector determines whether there is another role to process. If there is another role to process, then operational flow returns to block 303. Otherwise, operational flow proceeds to block 317. At block 317, the attack path detector determines whether there is another policy to process. If so, operational flow returns to block 301. If not, graph building is complete.

Embodiments can implement graph building or construction differently, including the encoding of information. Embodiments can encode graph structure information into nodes. As an example, while building the graph the attack path detector can maintain a count of incoming and outgoing edges for each node. Embodiments can maintain weights separately and lookup weights when scoring instead of encoding weights into the graph elements. For instance, the attack path detector may look up a base weight for a principal node and then adjust the weight based on information encoded in the principal node, such as increasing the weight for a third-party principal or a principal with stale credentials. The flowchart depicts example operations that start with roles to build a graph, but embodiments can start with either principals or resources, for instance when JSON formatting of security policies varies. Embodiments can also augment the graph based on inherited permissions and/or implied nodes and relationships.

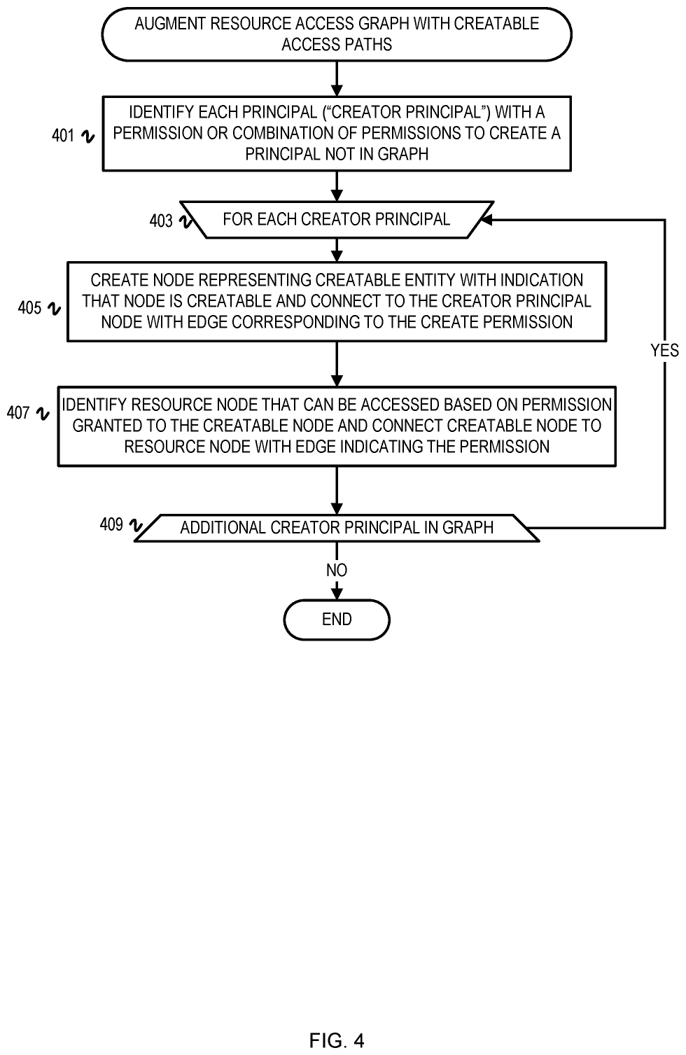

FIG. 4 is a flowchart of example operations for augmenting a resource access graph with a simulated access paths. An IAM system may provide permissions and/or actions that can yield “simulated” access paths, which are access paths to a resource that are not based on explicit information in policies. A simulated access path can arise from any one or more of temporary elevation of a role, delegation of credentials, inheritance of roles and/or permissions, passing of roles, delegation of credentials, etc. Augmenting the resource access graph with nodes and edges based on these non-explicit relationships reveals simulated paths that can be attack paths.

At block 401, the attack path detector identifies each principal in a resource access graph with a permission or combinations of permissions that allow creation of a principal not in the resource access graph. The attack path detector can analyze the policies subsequent to creation of an initial resource access graph to identify those of the principals with this capability (“creator principal”). Determination of whether a principal is a creator principal can be based on heuristics. For instance, indication of a wildcard for a resource field can be the basis for a principal being identified a creator principal because the principal can allow another role. Referring to FIG. 1, the policy entry 123 allows enggrp2 to run any compute instance and pass a role to the compute instance or another existing compute instance.

At block 403, the attack path detector begins to iterate over each identified creator principal. Each iteration includes the example operations of blocks 405, 407.

At block 405, the attack path detector creates a node representing the simulated entity with a label or other indication that the node is a simulated node and a node type. If the permitted action that allows creation of the entity relates to role assumption or role attachment, the attack path detector can set the node type as role. If the permitted action that allows creation of the entity does not relate to role attachment or passing, then the attach path detector indicates the node as a user type or compute instance type according to the permitted action. The attack path detector then connects the creator principal node to the simulated node with an edge labeled with the permitted action(s) that allows the creation. Referring again to the policy entry 123 of FIG. 1, the attack path detector indicates the simulated node as a compute instance and labels the edge based on the permitted actions of passing a role and running a compute instance.

At block 407, the attack path detector identifies a resource node that can be accessed based on the permission granted to the simulated node. The attack path detector reads the policy entry to determine a resource identifier and connects the simulated node to the corresponding resource node. From the policy entry, the attack path detector determines which action(s) permits the creator principal access to the resource node. The attack path detector then connects the simulated node to the resource node with an edge labeled according to the permitted action(s) of the creator principal.

At block 409, the attack path detector determines whether there is an additional creator principal to process. If there is an additional creator principal to process, operational flow returns to block 403. Otherwise, operational flow ends.

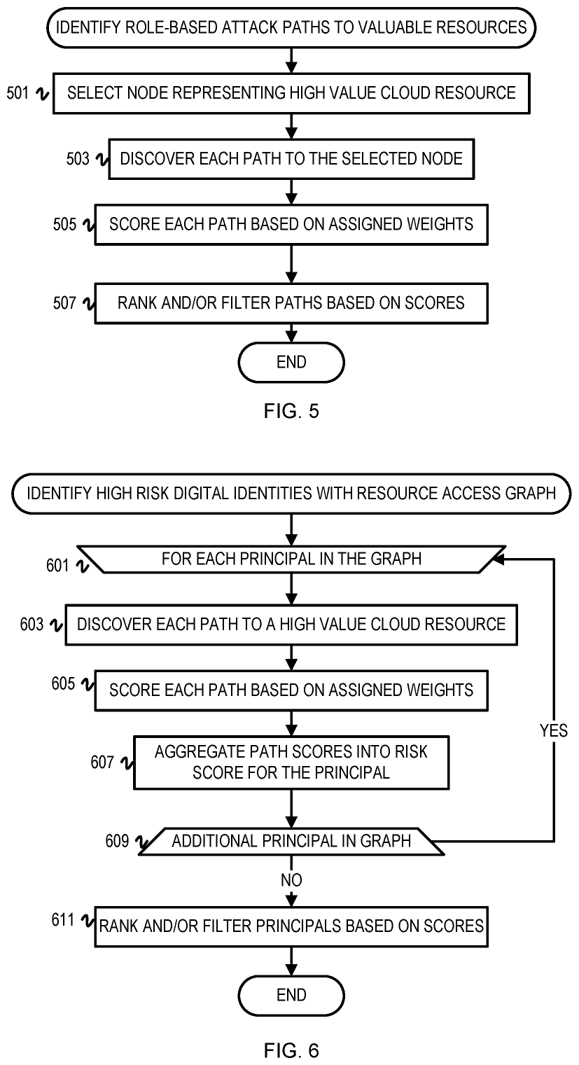

With the resource access graph, the attack path detector can discover attack paths, choke points, etc. The attack path detector can be programmed to analyze the resource access path to discover attack paths based on configured criteria and/or respond to queries. FIGS. 5 and 6 are flowcharts depicting example operations for different triggers of attack path discovery.

FIG. 5 is a flowchart of example operations for identifying attack paths to valuable resources of an organization. The example operations presume attack path discovery is prompted by selection of a resource corresponding to a high value asset.

At block 501, the attack path detector selects a node representing a high value cloud resource. Input to the attack path detector can specify a criterion for selecting a resource for attack path discovery. The input can specify an identifier of a resource (e.g., storage object) in which a high-value resource is stored. The attack path detector can then search the graph for the node encoded with the resource identifier. As another example, a node presented in a graphical user interface can be selected.

At block 503, the attack path detector discovers each path to the selected node. The attack path detector can run an algorithm (e.g., depth first search) to discover the access paths to the selected node. The attack path detector can be programmed to determine paths to each sink node (i.e., a node with 0 out-degrees) in advance, since each resource node will be a sink node. In this case, path discovery for all sink nodes is completed in advance and updated when the graph is updated and the attack path detector can retrieve pre-discovered paths in response to a node selection.

At block 505, the attack path detector scores each path to the selected node based on the assigned weights. An example formula for scoring a path is

$$score ( path ) = {\sum }_{j = 1}^{n} {w}_{j} * {\sum }_{i = 1}^{m} {x}_{i} * \frac{{asset}_{weight}}{{path}_{length}}$$

where wⱼ represents the weights of the n nodes traversed in the path, xᵢ represents the weights of the m edges in the path, asset_weight represents the weight assigned to the asset and/or the storage resource, and path_length represents the length of the path which is probably n. Implementations can assign a weight to the resource as previously described, but this is not necessary. While a resource may have its own values, the weight assigned to a resource is likely an attempt to quantify the risk/value of the asset. The weight assigned to a resource can be a sum of the weights of high-value assets within a resource. The above function is non-negative, monotonic, and superadditive. In addition, the scoring function is more sensitive to change in path length than changes in the weights or attributes of graph elements that influence the weights.

At block 507, the attack path detector ranks and/or filters the discovered paths based on the scoring. Scoring quantifies the criticality of the attack path which could be used for triage, for example. The example scoring formula is intended to quantify how critical a path to a resource is with respect to path length. A shorter path is more likely to have a higher score because the shorter path can be easier to exploit. Ranking based on the scoring allows resources to be expended efficiently to identify the most critical paths (among possibly thousands of paths) and remediate those paths. Filtering can be used to further conserve resources (e.g., display space) for the most critical attack paths above a threshold or that satisfying a filtering criteria (e.g., only show those paths with source node representing external accounts). The ranked and/or filtered paths can be indicated via a user interface with or without scores (e.g., a graphical display of the graph can be updated to focus on the attack paths), written to a file, stored in memory, etc.

FIG. 6 is a flowchart of example operations to identify high risk digital identities with the resource access graph. At block 601, the attack path detector begins processing each principal in the graph. The attack path detector can begin with the source nodes in the graph. At block 603, the attack path detector discovers each access path from the principal node to a high value cloud resource. Value of a resource can be dynamically determined based on the assets hosted by the resource (e.g., a virtual server or storage object). The attack path detector can discover paths from a first endpoint that is the principal node to every sink node and then evaluate the sink node to determine whether it is a resource that hosts a high value asset. As another example, the attack path detector can first filter out sink nodes or mark sink nodes that do not host a high value asset and then proceed from those endpoints to source nodes. In some cases, attack path discovery is not dependent on whether a resource hosts a high value asset since the potential exists for the resource to host a high value asset. At block 605, the attack path detector scores each path based on the assigned weights. At block 607, the attack path detector aggregates path scores into a risk score for the principal. At block 609, the attack path detector determines whether there is an additional principal in the graph to evaluate. If there is an additional principal to evaluate, then operational flow returns to block 601. Otherwise, operational flow proceeds to block 611. At block 611, the attack path detector ranks and/or filters principals based on the risk scores.

FIGS. 5 and 6 only present some of the attack path analysis possible with the IAM policy based resources access graph. Graph analysis algorithms for betweenness and/or centrality can identify other aspects of attack paths. For instance, choke points can be identified instead of paths or in combination with paths to determine efficient remediations. In addition, the resource access graph can be used to extract rules to prevent recurrence of an attack and/or remediate misconfigurations.

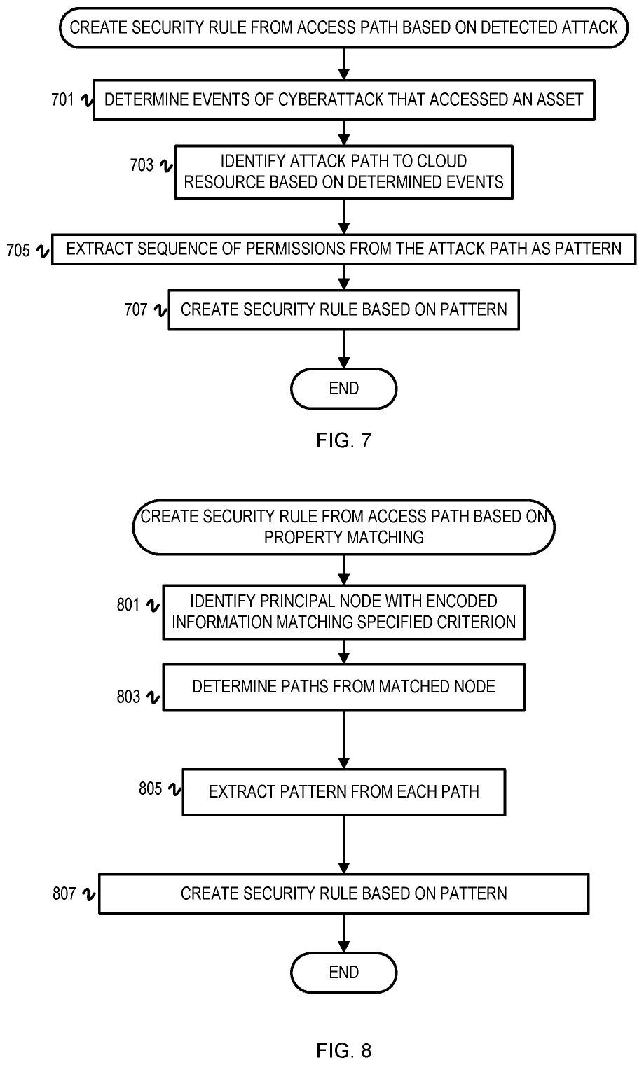

FIG. 7 is a flowchart of example operations for creating a security rule from an access path based on a an actual cyberattack. At block 701, the attack path detector determines events of real-world cyberattack in which an asset was accessed. The attack may have occurred in a customer environment or be disclosed in a public report. The events of the attack are determined, for example, based on audit logs. At block 703, the attack path detector identifies an attack path based on the series of events of the actual cyberattack. For example, the attack path detector traverses paths of a resource access graph to identify a path with a sequence of principals and permissions or actions that sufficiently match events of the actual attack. Matching principals can be based on type (e.g., compute instance or role) and edge labels that match the permissions and actions of the attack events. In some cases, the attack path detector can deem a path as a match based on sequence of edge labels matching permissions and actions in the sequence of events. At block 705, the attack path detector extracts a sequence of permissions from the identified attack path as a pattern. With the pattern, the attack path detector creates a security rule at block 707. For example, the attack path detector extracts the sequence of RunInstance, PassRole, RunInstance, AssumeRole, GetObject as a pattern. The rule can be generalizable across tenants or customers of a cloud platform since the platform likely uses the same grammar. To create the rule, the attack path detector associates the extracted pattern with a remediation action, such as flag source node or remove permissions of source node. The rule can then be applied to other accounts or organizations to prevent the attack since the pattern itself does not include proprietary information or identifiable information of a tenant/customer.

FIG. 8 is a flowchart of example operations for creating a security rule from an access path based on a property matching. At block 801, the attack path detector identifies a principal node with encoded information matching one or more specified criterion. For example, a criterion might be any principal node with a specified vulnerability or a principal node with un-rotated credentials. At block 803, the attack path detector determines paths from the matched node. If more than one principal node matches the specified criterion or criteria, then the attack path detector will process each matching node. Since a matched node may be an intermediate node on an access path, exploring paths may include reverse traversal over incoming edges to determine an access path. Specified criteria may include a criterion that corresponds to either type of endpoint, a sink and/or source node, thus not every path on which the matched node resides may be of interest for this rule creation. At block 805, the attack path detector extracts a pattern from each determined path. The extracted pattern includes the properties that match the criteria as well as information for the rest of the path. At block 807, the attack path detector creates a security rule based on the extracted pattern. For instance, a rule creation query may specify a Common Vulnerabilities and Exposures (CVE) identifier CVE 2022-17438. The attack path detector determines a path that includes a node representing a principal with the CVE and extracts a pattern “<InternetExposedNode>->Exploits CVE 2022-17438->RunComputeInstances->PassRole->RunComputeInstances->AssumesRole->GetObject.” Associating this pattern with a remediation action creates a rule that can be applied to another resource access graph to remediate the attack path existing in the organization corresponding to that other resource access graph.

As another example proactive security use case, a resource access graph can be evaluated to extract a pattern from a risky path and construct a rule that can be applied to events. The attack path detector can select an attack path, such as a highest ranking attack path. The attack path detector extracts a pattern from the selected attack path. For example, the attack path detector extracts a sequence of principal types and permission or action edge labels to form a pattern. The pattern may be processed to make “translations” from the access path vocabulary to an event log vocabulary. For example, terms in the attack path pattern may be platform independent and translated to platform specific terms. A rule can then be constructed from the pattern extracted from the attack path and used to monitor events.

### Variations

A resource access graph as disclosed herein can be used for additional attack path analysis. For instance, graphs corresponding to before and after policy configuration changes can be compared to reveal deltas in attack paths. A resource access graph can be used to identify all access paths between specified source and sink nodes. The description referred to filtering primarily with respect to scoring, but the filtering can filter on properties of elements of a path. In addition to or instead of prioritizing based on scoring, prioritizing for remediation can be based on properties. For instance, filtering can prioritize principals with un-rotated credentials or workloads with vulnerabilities. Filtering can prioritize attack paths with bastion hosts having long lived or permanent keys exploitable for lateral movement. In addition, the attack path detector can interface with other systems to prioritize paths. For example, the attack path detector can query a network monitoring system for workloads with unusual activity (e.g., abnormal traffic volume, unusual login behavior, etc.) and filter attack paths to prioritize those paths with nodes representing these workloads.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIG. 3 can create resource nodes initially and build the graph in reverse. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

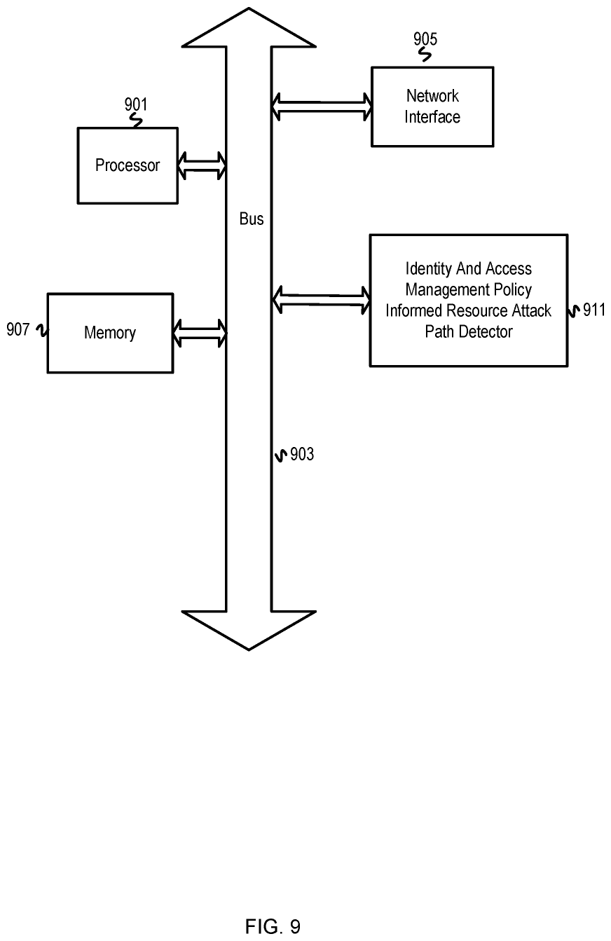

FIG. 9 depicts an example computer system with an IAM policy informed resource attack path detector. The computer system includes a processor 901 (possibly including multiple processors, multiple cores, multiple nodes, and/or implementing multi-threading, etc.). The computer system includes memory 907. The memory 907 may be system memory or any one or more of the above already described possible realizations of machine-readable media. The computer system also includes a bus 903 and a network interface 905. The system also includes an IAM policy informed resource attack path detector 911. The IAM policy informed resource attack path detector 911 builds a graph based on parsing IAM security policies, which may be user-based policies and/or resource-based policies, to discover role-based attack paths to resources hosted in a cloud environment. The IAM policy informed resource attack path detector 911 determines relationships among principals and resources as expressed in the role bindings of the policies as related by permissions granted to the principals by roles. After capturing the principal->permission(s)->resource relationships in the graph, access paths to resources that are potential attack paths are revealed. Often, the attack paths include permission allowing escalation of privileges, temporary credentials, delegation, inheritance, etc. Any one of the previously described functionalities may be partially (or entirely) implemented in hardware and/or on the processor 901. For example, the functionality may be implemented with an application specific integrated circuit, in logic implemented in the processor 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901 and the network interface 905 are coupled to the bus 903. Although illustrated as being coupled to the bus 903, the memory 907 may be coupled to the processor 901.

### Terminology

This description uses the term “workload.” A workload is a collection of resources and code that implement, for example, software-as-a-service or a backend process.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
building a graph with nodes representing principals and cloud computing resources and with edges representing permissions, wherein building the graph comprises,
parsing identity and access management policies to determine the principals and permissions assigned to principals; and
connecting nodes with edges based on the permissions and assignments of the permissions; and
evaluating the graph to discover one or more potential attack paths to at least a first of the cloud computing resources.

2. The method of claim 1 further comprising modifying the graph to include a simulated principal node and connecting the simulated principal node to the graph based on at least one of the permissions, wherein the simulated principal node is a node that represents a principal that could be created according to at least one of the permissions.

3. The method of claim 2, wherein modifying the graph to include the simulated principal node comprises creating the simulated principal node based on a first of the permissions assigned to at least a first of the principals and wherein connecting the simulated principal node to the graph is based, at least in part, on a second of the permissions that can be assigned to the simulated principal node.

4. The method of claim 1, wherein building the graph further comprises assigning weights to the nodes and edges based, at least in part, on types of the principals, permissions of the edges, and resource classifications.

5. The method of claim 4, wherein evaluating the graph to discover one or more potential attack paths to at least a first cloud computing resource comprises selecting a node as a first endpoint and determining one or more paths from the first endpoint to one or more second endpoints in the graph, computing a score for each path in the graph based, at least partly, on the assigned weights and ranking and/or filtering the potential attack paths according to the scores, wherein either the first endpoint or the one or more second endpoints represents the cloud computing resource.

6. The method of claim 5 further comprising prioritizing remediation of discovered attack paths based, at least partly, on the scores.

7. The method of claim 1 further comprising creating a rule based on an attack path to one of the cloud computing resources discovered from evaluating the graph and providing the rule to prevent similar attack paths.

8. The method of claim 7, wherein creating the rule comprises extracting a sequence of permissions in the attack path and creating the rule based, at least in part, on the extracted sequence of permissions.

9. The method of claim 1, wherein evaluating the graph to discover one or more potential attack paths to at least a first cloud computing resource comprises evaluating the graph to determine one or more potential attack paths to the first cloud computing resource from a first digital identity.

10. A non-transitory, machine-readable medium having program code stored thereon, the program code comprising instructions to:
build a directed graph based on a plurality of identity and access management policies, wherein the directed graph comprises nodes that represent principals and cloud computing resources and edges that connect nodes based on permissions assigned to the principals in the plurality of identity and access management policies; and
augment the directed graph to indicate one or more potential access paths based on a first subset of the permissions, wherein the instructions to augment the directed graph comprise instructions to,
create a node based on a first of the subset of permissions assigned to a first of the principals that allows creation of another principal by the first principal; and
connect the created node to the directed graph based on a second of the subset of permissions assigned to the first principal; and
evaluate the directed graph to discover whether there is an attack path to a cloud computing resource represented in the directed graph.

11. The non-transitory, machine-readable medium of claim 10, wherein the instructions to build the directed graph comprise instructions to parse the plurality of identity and access management policies to determine the principals and permissions assigned to the principals.

12. The non-transitory, machine-readable medium of claim 10, wherein the program code further comprises instructions to assign weights to the nodes and the edges based, at least in part, on types of the principals, permissions of the edges, and resource classifications.

13. The non-transitory, machine-readable medium of claim 12, wherein the instructions to evaluate the directed graph to discover whether there is an attack path to a cloud computing resource represented in the directed graph comprise instructions to select a first endpoint node and determine one or more paths through the graph to one or more second endpoint nodes, compute a score for each path based, at least partly, on the assigned weights and to rank and/or filter the attack paths according to the scores, wherein either the first endpoint or the one or more second endpoints represents the cloud computing resource.

14. The non-transitory, machine-readable medium of claim 13, wherein the program code further comprises instructions to prioritize remediation of discovered attack paths based, at least in part, on the scores.

15. The non-transitory, machine-readable medium of claim 10, wherein the program code further comprises instructions to create a rule based on a discovered attack path to one of the cloud computing resources and provide the rule to prevent similar attack paths.

16. The non-transitory, machine-readable medium of claim 15, wherein the instructions to create the rule comprise instructions to extract a sequence of permissions in the attack path and create the rule based, at least in part, on the extracted sequence of permissions.

17. An apparatus comprising:
a processor; and
a machine-readable medium having instructions stored thereon that are executable by the processor to cause the apparatus to,
build a graph with nodes representing principals and cloud computing resources and with edges representing permissions, wherein the instructions to build the graph comprise instructions executable by the processor to cause the apparatus to,
parse identity and access management policies to determine principals and permissions assigned to principals; and
connect nodes with edges based on the permissions and assignments of permissions; and
evaluate the graph to discover one or more potential attack paths to at least a first of the cloud computing resources.

18. The apparatus of claim 17, wherein the machine-readable medium further has stored thereon instructions executable by the processor to cause the apparatus to modify the graph to include a simulated principal node and to connect the simulated principal node to the graph based on at least one of the permissions, wherein the simulated principal node is a node that represents a principal that could be created according to at least one of the permissions.

19. The apparatus of claim 18, wherein the instructions to modify the graph to include the simulated principal node comprise instructions executable by the processor to cause the apparatus to create the simulated principal node based on a first of the permissions assigned to at least a first of the principals and wherein the instructions to connect the simulated principal node to the graph is based, at least in part, on a second of the permissions that can be assigned to the simulated principal node.

20. The apparatus of claim 17,
wherein the instructions to build the graph further comprise instructions executable by the processor to cause the apparatus to assign weights to the nodes and edges based, at least in part, on types of the principals, permissions of the edges, and resource classifications,
wherein the instructions to evaluate the graph to discover one or more potential attack paths to at least a first cloud computing resource comprise the instructions being executable by the processor to cause the apparatus to compute scores for paths in the directed graph to node representing cloud computing resources based, at least partly, on the assigned weights and to rank and/or filter the potential attack paths according to the scores.
